(19) United States
(12) Patent Application Publication
(10) Pub. No.: US 2004/0103995 A1
(43) Pub. Date: Jun. 3, 2004

(54) Blind lifting control method and mechanism

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: NIEN MADE ENTERPRISE CO., LTD., Taichung (TW)

(21) Appl. No.: 10/384,524

(22) Filed: Mar. 11, 2003

(30) Foreign Application Priority Data
Nov. 29, 2002 (TW) 91134714

(51) Int. Cl. E06B 9/30

(52) U.S. Cl. 160/170

(57) ABSTRACT

A blind lifting control mechanism for use in a blind and adapted to control the elevation of the blind body is constructed to include two bobbins pivotally mounted inside a headrail of the blind, a transmission mechanism mounted inside the headrail of the blind and coupled to the bobbins, and a control rod vertically suspended at a side of a window and coupled to the transmission mechanism for rotating by the user to drive the transmission mechanism to rotate the bobbins to roll up/let off the lift cords of the blind body and to further lift/lower the blind body.

### BACKGROUND OF THE INVENTION

1. Field of the Invention

The present invention relates to blinds, and more specifically to a blind lifting control mechanism and a method of the same.

2. Description of the Related Art

A variety of blinds including Venetian blinds, roller blinds, pleated blinds, honeycomb shades, Roman blinds, vertical blinds, curtains, and so on are commercially available for use in a window to regulate the light, air, etc. A regular blind generally includes a headrail fastened to a top side of the window, and a blind body (formed of a shade or a set of slats, and a bottom rail) mounted at a bottom side of the headrail. The blind body is driven by an external driving force to change its window shading status.

The blind lifting control mechanism of a conventional blind generally includes at least one bobbin, regularly two bobbins rotatably mounted with the headrail of the blind and adapted to roll up or let off lift cords of the blind and to further lift or lower the blind body (in an alternate prior art design, a roller is used instead of the bobbin, and the top side of the blind body is directly fastened to the periphery of the roller), a transmission mechanism mounted inside the headrail of the blind and coupled to the bobbins, and an endless operating cord member suspended from the headrail of the blind at an end for pulling by hand to drive the transmission mechanism to rotate the bobbins (or the roller). There is another conventional design in which each of the two lift cords has a first end fastened to the bottom side of the blind body (for example, the bottom rail of the blind body), and a second end inserted inside the headrail of the blind and through a lift lock in the headrail and then downwardly extended out of the bottom side of the headrail to a distance. The user can pull the lift cords to lift or lower the blind body. When the lift cords are released, the lift lock automatically locks the lift cords.

In the aforesaid prior art designs, the operating cord member or lift cords are suspended outside the headrail. Because a child can easily reach the suspended part of the lift cords or operating cord member, an accident may occur when a child pulls the lift cords or operates the cord member for fun.

### SUMMARY OF THE INVENTION

It is primary objective of the present invention to provide a blind lifting control mechanism, which keeps cord members of the blind in a hidden status, eliminating the possibility of a person, especially a child, hanged on cord members of the blind accidentally.

To achieve the foregoing objective of the present invention, the blind lifting control mechanism includes a control rod vertically suspended at a lateral side of the window, two bobbins rotatably mounted with the headrail of the blind for synchronous rotation to roll up or let off lift cords of the blind and to further lift or lower the blind body of the blind, and a transmission mechanism coupled between the control rod and the bobbins. When the user rotates the control rod by hand or through a rotary driving device, the bobbins are rotated clockwise or counterclockwise to roll up or let off the lift cords of the blind, and to further lift or lower the blind body of the blind.

### BRIEF DESCRIPTION OF THE DRAWINGS

FIG. 1 is an elevation view showing a blind lifting control mechanism installed in a Venetian blind according to a first preferred embodiment of the present invention.

FIG. 2 is an enlarged view of a part of FIG. 1, showing the arrangement of a transmission mechanism in a headrail of the blind.

FIG. 3 is a sectional view in an enlarged scale taken along a line 3-3 indicated in FIG. 2.

FIG. 4 is a schematic sectional view showing a control rod moved relative to the headrail of the blind.

FIG. 5 is a perspective view showing that the crank handle is at an operative position according to the first preferred embodiment of the present invention.

FIG. 6 is a perspective view showing that the crank handle is at a non-operative position according to the first preferred embodiment of the present invention.

FIG. 7 is an exploded view of a blind lifting control mechanism installed in a Venetian blind according to a second preferred embodiment of the present invention.

FIG. 8 is an exploded view of a blind lifting control mechanism installed in a Venetian blind according to a third preferred embodiment of the present invention.

FIG. 9 is a sectional view of a part of a fourth preferred embodiment of the present invention, showing a movable device is at a locking position.

FIG. 10 is a sectional view taken along a line 10-10 indicated in FIG. 9.

FIG. 11 is similar to FIG. 9 but showing the movable device moved to a unlocking position.

### DETAILED DESCRIPTION OF THE INVENTION

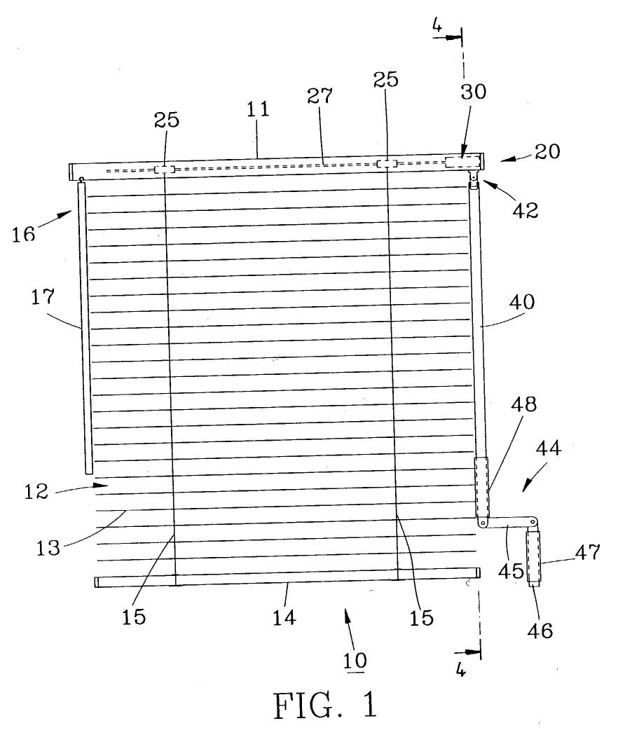

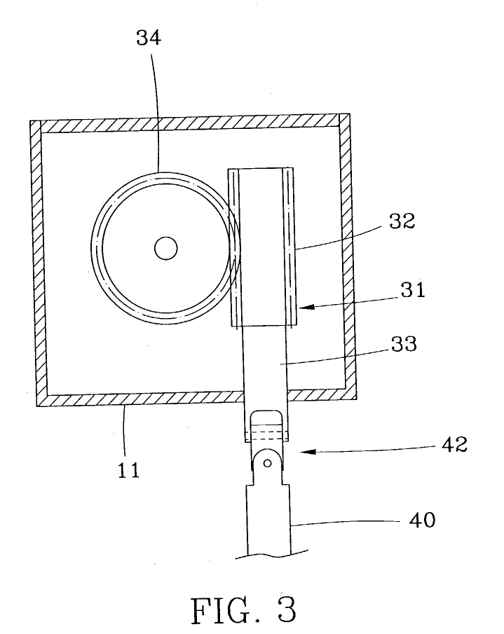

Referring to FIGS. 1-3, a blind lifting control mechanism 20 in accordance with a first preferred embodiment of the present invention is shown installed in a Venetian blind 10 for lifting control. The Venetian blind 10 includes a headrail 11, which is a hollow bar fixedly fastened to a topside of a window, a blind body 12, which is composed of a number of transversely extended parallel slats 13 and a bottom rail 14 suspended below the slats 13, two lift cords 15 bilaterally and vertically inserted through the slats 13, each lift cord 15 having a bottom end fixedly connected to the bottom rail 14 and a top end inserted into the inside of the headrail 11 (this will be described further), and a tilt control mechanism 16 adapted to regulate the tilting angle of the slats 13. The tilt control mechanism 16 includes a tilt rod 17 vertically suspended from the headrail 11 at a left side thereof and adapted to rotate a tilt rod via a worm gear and tilter mechanism, causing the tilt rod to move two ladder tapes and to further change the tilting angle of the slats 13. Because the tilt control mechanism 16 is a conventional design, no further detailed description is necessary.

The blind lifting control mechanism 20 includes two bobbins 25 symmetrically mounted on an axle 27 inside the headrail 11 for synchronous rotation with the axle 27 to roll up or let off the lift cords 15, a transmission mechanism 30 mounted inside the headrail 11 near a right side thereof, and a control rod 40.

The transmission mechanism 30 includes a worm 31, which includes a worm body 32 vertically suspended inside the headrail 11 and a round rod 33 axially extended from the bottom end of the worm body 32 and partially extended out of the bottom side of the headrail 11, a worm gear 34 disposed inside the headrail 11 behind the worm 31 and meshed with the worm body 32, a gear set 35 connected between the worm gear 34 and the axle 27 and adapted to transmit rotary driving force from the worm gear 34 to the axle 27, i.e., the worm gear 34 is the driving force input end of the gear set 35 and the axle 27 is the driving force output end of the gear set 35. The gear set 35 may be variously embodied. For example, the gear set 35 can be a gear train composed of a series of gears of different diameters meshed with one another, or formed of a number of gears coaxially meshed with one another.

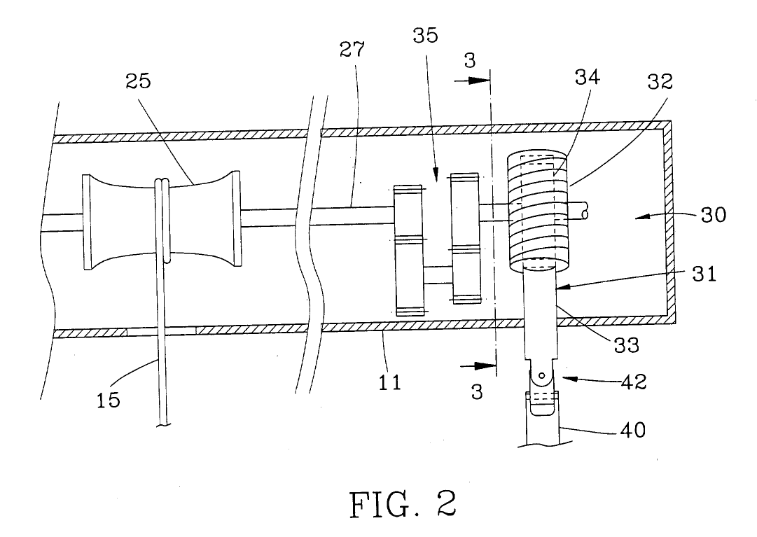

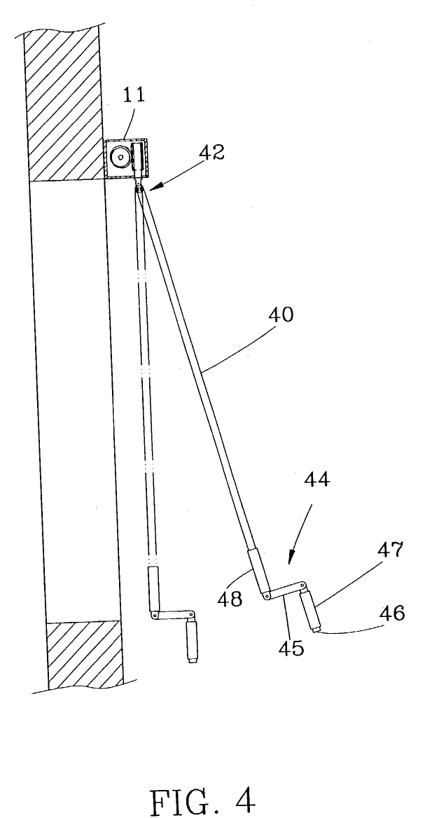

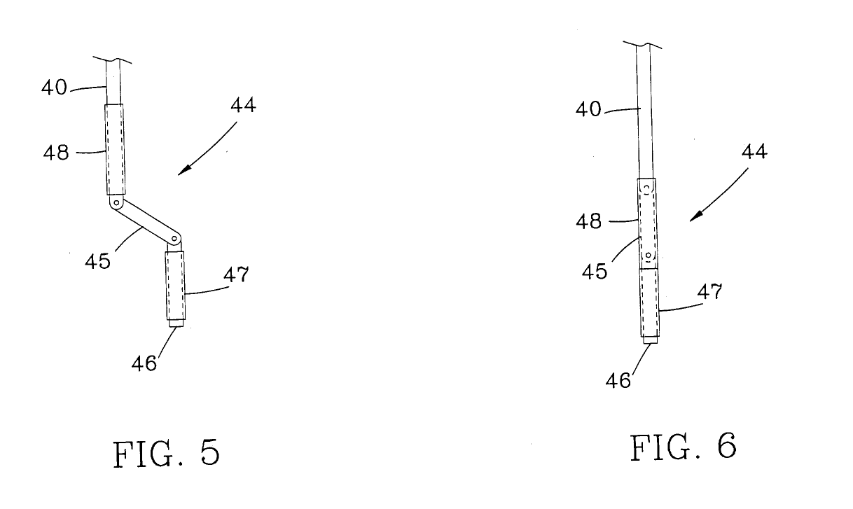

The control rod 40 is vertically suspended from the headrail 11 at a right side thereof, having a top end connected to the round rod 33 of the worm 31 by a universal joint 42. Thus, the control rod 40 can be oscillated toward inside of the room relative to the worm 31 (see FIG. 4). The control rod 40 has a bottom end mounted with a manual rotary driving device, for example, a crank handle 44. The crank handle 44 includes a first arm 45 foldably pivoted to a bottom end of the control rod 40, a second arm 46 foldably pivoted to an end of the first arm 45 remote from the control rod 40, a grip 47 coupled to the second arm 46 for free rotation relative to the second arm 46, and a sleeve 48 fitted to the control rod 40 for free rotation and axial movement relative to the control rod 40. The sleeve 48 is longitudinally longer than the first arm 45. When in use, as shown in FIGS. 1 and 2, the first arm 45 is set in a horizontal position perpendicular to the control rod 40, the second arm 46 is set in a vertical position perpendicular to the first arm 45, and the sleeve 48 connected to a bottom end of the control rod 40 and being stopped against the first arm 45. When not in use, as shown in FIGS. 5 and 6, the first arm 45 and the second arm 46 are pulled downwards and vertically aligned with the control rod 40, and the sleeve 48 is pulled downwards and stopped above the grip 47 around the first arm 45 and the pivoted connecting area between the control rod 40 and the first arm 45 as well as the pivoted connecting area between the first arm 45 and the second arm 46. Therefore, the sleeve 48 locks the control rod 40, the first arm 45, and the second arm 46 in alignment.

When wishing to adjust the elevation of the blind 12, move the control rod 40 in direction from the window toward the inside of the room and set the crank handle 44 in an operative position as shown in FIG. 4, and then hold the sleeve 48 with one hand and drive the grip 47 with the other hand to rotate the control rod 40 relative to the sleeve 48. Rotating the control rod 40 causes the worm 31 to rotate the worm gear 34, the gear set 35 and the axle 27, thereby causing the bobbins 25 to roll up or let off the lift cords 15 subject to the direction of rotation of the control rod 40. Therefore, the blind 12 is received upwards or extended downwards.

According to the aforesaid embodiment, the aforesaid worm and worm gear mechanism transmits driving force in one direction only (i.e., the worm 31 rotates the worm gear 34 when receiving a rotary driving force, however the worm 31 stops a rotary driving force coming from the worm gear 34), therefore the user can control the control rod 40 to rotate the bobbins 25, and a self-locking mechanism of the aforesaid worm and worm gear mechanism automatically locks the bobbins 25 when the user adjusted the blind 12 to the desired elevation, i.e., the blind 12 is positively positioned at the adjusted elevation.

As indicated above, the invention does not use any lift cord or like means to achieve blind lifting control, it eliminates the possibility of a person (more particularly a child) hanged on the lift cord accidentally. Therefore, the blind is safe for use and fits blind safety codes in advanced countries.

The aforesaid blind lifting control mechanism can also be used in another equivalent blind, for example, a pleated blind, honeycomb shade, or roman blind. When it's used in a roller blind, a roller is used instead of the two bobbins and, the top side of the blind body is fastened to the periphery of the roller.

In the aforesaid embodiment, a crank handle 44 is mounted at the bottom side of the control rod 40 of the lifting control mechanism 20 for enabling the user to rotate the control rod 40 with less effort. However, this crank handle 44 is not requisite. An accelerating mechanism may be installed in the transmission mechanism 30 so that the user can rotate the straight control rod 40 directly without much effort.

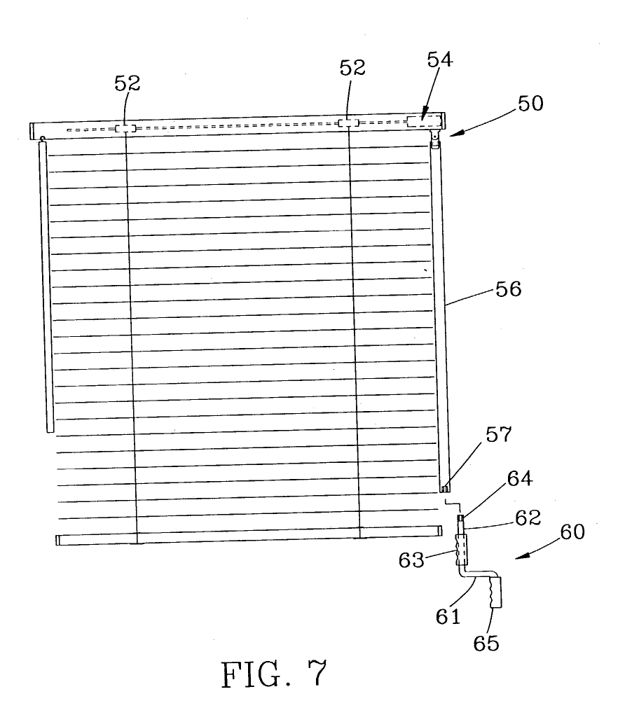

FIG. 7 shows a blind lifting control mechanism according to a second preferred embodiment of the present invention. According to this embodiment, the blind lifting control mechanism 50 includes two bobbins 52 (similar to the bobbins of the aforesaid first embodiment), a transmission mechanism 54(similar to the transmission mechanism of the aforesaid first embodiment), a control rod 56, and a detachable crank handle 60. The control rod 56 has a coupling device at a bottom end thereof, for example, a hexagonal coupling hole 57. The crank handle 60 includes a L-shaped crank arm 61, a driving rod 62 axially forwardly extended from an end of the L-shaped crank arm 61 and terminating in a coupling device, for example, a hexagonal coupling tip 64 that fits the hexagonal coupling hole 57, a sleeve 63 sleeved onto the driving rod 62 for free rotation, and a grip 65 perpendicularly extended from the other end of the L-shaped crank arm 61 in direction reversed to the driving rod 62. When in use, the crank handle 60 is attached to the bottom end of the control rod 56 for enabling the user to rotate the control rod 56 with less effort. After use, the crank handle 60 is removed from the control rod 56. According to this embodiment, a single crank handle 60 can be used to rotate the lifting control mechanisms of multiple blinds in a house.

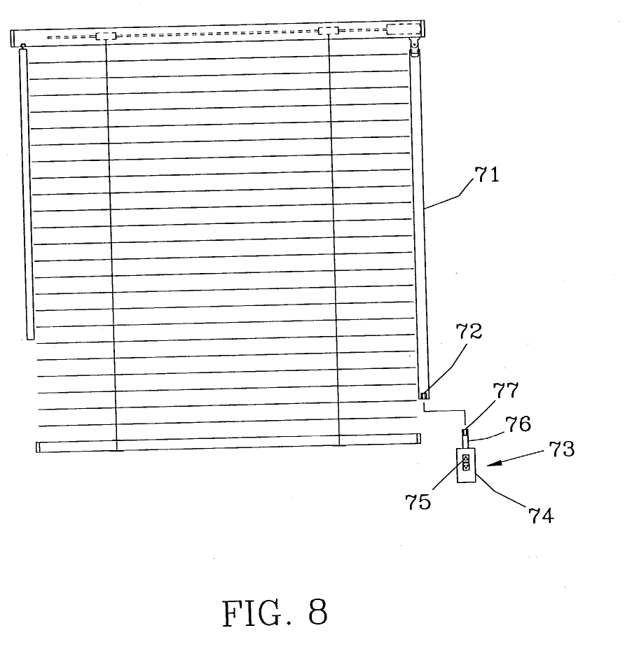

FIG. 8 shows a blind lifting control mechanism according to a third preferred embodiment of the present invention. According to this embodiment, an electric rotary driving device 73 is used for rotating the control rod 71. Similar to the aforesaid second embodiment, the control rod 71 has a coupling portion, for example, a hexagonal coupling hole 72 at the bottom end thereof The electric rotary driving device 73 includes a housing 74, a battery power supply and motor assembly (not shown) mounted inside the housing 74, a driving shaft 76 extended from the output shaft of the reversible motor of the battery power supply and motor assembly out of the housing 74 and terminating in a coupling device, for example, a hexagonal coupling tip 77 that fits the hexagonal coupling hole 72 of the control rod 71, and a switch 75 adapted to control on/off and forward/backward rotation of the reversible motor of the battery power supply and motor assembly. By means of the electric rotary driving device 73, the user can conveniently rotate the control rod 71 without effort.

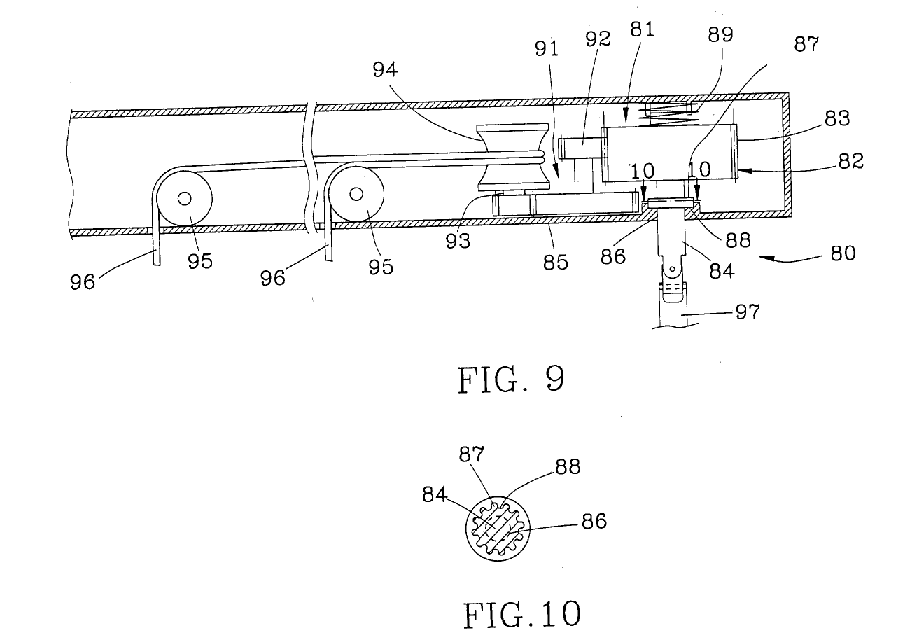

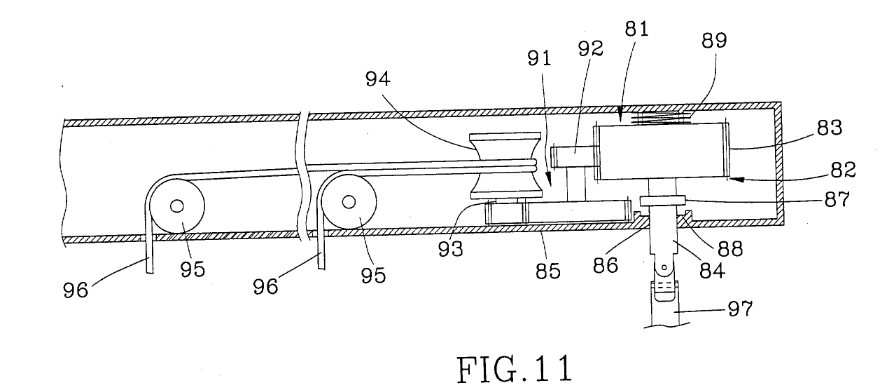

FIGS. 9-11 show a blind lifting control mechanism according to a fourth preferred embodiment of the present invention. According to this embodiment, the blind lifting control mechanism 80 includes a transmission mechanism 81, a bobbin 94, two pulleys 95, and a control rod 97. The transmission mechanism 81 includes a movable device 82, a spring member 89, and a gear set 91. The movable device 82 includes a cylindrical gear 83 horizontally suspended inside a right side of the headrail 85, a rod member 84 coaxially connected to the cylindrical gear 83 and extended out of a circular through hole 86 in the bottom side of the headrail 85 and pivoted to the top end of the control rod 97, a toothed groove 88 formed in the headrail 85 around the circular through hole 86 at a top side, and a toothed collar 87 fixedly provided around the periphery of the rod member 84 and moved vertically with the rod member 84 between a locking position where the toothed collar 87 engages the toothed groove 88 to stop the rod member 84 from rotation (see FIGS. 9 and 10), and an unlocking position where the toothed collar 87 is disengaged from the toothed groove 88 for enabling the rod member 84 to be rotated by the control rod 97 (see FIG. 11). The spring member 89 is connected between an inner surface of the top wall of the headrail 85 and the top side of the cylindrical gear 83 to support the movable device 82 in the aforesaid locking position. The gear set 91 includes an input gear 92 horizontally meshed with the cylindrical gear 83, and an output shaft 93 disposed in a vertical position for output of force. The bobbin 94 is fixedly mounted on the output shaft 93. The pulleys 95 are rotatably fastened with the headrail 85 at locations corresponding to the lift cords 96, and adapted to guide the lift cords 96 to the bobbins 94, for enabling the bobbins 94 to roll up or let off the lift cords 96 upon rotary motion of the output shaft 93. When wishing to adjust the elevation of the blind, push the control rod 97 upwards to lift the toothed collar 87 from the locking position shown in FIG. 9 to the unlocking position shown in FIG. 11, and then drive the control rod 97 to rotate the movable device 82 forwards or backwards. When rotating the movable device 82, the gear set 91 is driven to rotate the bobbin 94, thereby causing the bobbin 94 to roll up or let off the lift cords 96. When the blind lifted or lowered to the desired elevation, pull the control rod 97 downwards to move the toothed collar 87 from the unlocking position shown in FIG. 11 to the locking position shown in FIG. 9.

According to the aforesaid embodiments, the bobbin or bobbins for moving the lift cords of the blind can be designed to position inside the headrail either in a vertical position or a horizontal position. Further, the transmission mechanism for transmitting a rotary driving force from the control rod to the bobbin or bobbins must have a self-locking feature to stop reverse transmission of force from the force output end (the bobbin or bobbins) to the force input end (the control rod). The transmission mechanism has the capability of increasing the speed of revolution.

What is claimed is:

1. A blind lifting control mechanism installed in a blind that includes a headrail mounted at a top side of a window and a blind body mounted under said headrail, said blind lifting control mechanism comprising:
at least one bobbin rotatably fastened to said headrail of said blind for synchronous rotation to lift or lower the blind body of said blind;
a transmission mechanism mounted inside said headrail of said blind and adapted to rotate said bobbin, said transmission mechanism having a rotating force input end disposed in an end of the headrail, a rotating force output end connected to said bobbin, and means for stopping reverse transmission of force from said force output end toward said force input end; and
a control rod vertically suspended at a lateral side of the window and pivoted to the force input end of said transmission mechanism and adapted to rotate the force input end of said transmission mechanism by the user and to further drive said transmission mechanism to rotate said bobbin.

2. The blind lifting control mechanism as defined in claim 1, wherein said transmission mechanism comprises a worm corresponding to said force input end and a worm gear corresponding to said force output end, said worm and said worm gear being engaged with each other.

3. The blind lifting control mechanism as defined in claim 1, wherein said force input end of said transmission mechanism is a movable device, said movable device having a cylindrical gear horizontally suspended inside said headrail of said blind, a rod member coaxially connected to said cylindrical gear and downwardly extended out of said headrail of said blind and pivoted to a top end of said control rod, a toothed endless groove fixedly located on a part inside the headrail of said blind, a toothed collar fixedly provided around the periphery of said rod member and vertically movable with said rod member between a locking position where said toothed collar engages said toothed endless groove to stop said rod member from rotation, and an unlocking position where said toothed collar is disengaged from said toothed endless groove for enabling said rod member to be rotated by said control rod, a spring member connected between a part of the headrail and a part of said cylindrical gear to support said movable device in the locking position, and gear set meshed with said cylindrical gear and located between said force input end and said force output end.

4. The blind lifting control mechanism as defined in claim 1, wherein said transmission mechanism further comprises a transmission gear set coupled between said force input end and said force output end and adapted to accelerate the speed of a rotary driving force received by said force input end and then to transmit the rotary driving force to said bobbin through said force output end.

5. The blind lifting control mechanism as defined in claim 1, wherein said control rod has a top end connected to the force input end of said transmission mechanism through a universal joint.

6. The blind lifting control mechanism as defined in claim 1, wherein said control rod has a bottom end provided with a collapsible crank handle, said collapsible crank handle having a first arm, said first arm having a first end pivoted to the bottom end of said control rod and a second end, a second arm having a first end pivoted to a second end of said first arm and a second end, a grip coupled to the second end of said second arm for free rotation relative to said second arm, and a sleeve sleeved onto said control rod for free rotation and axially movable along said control rod onto said first arm and the first end of said second arm to hold said control rod, said first arm and said second arm being aligned with each other.

7. The blind lifting control mechanism as defined in claim 1, wherein said control rod has a coupling portion at a bottom end thereof; the blind lifting control mechanism further comprises a rotary driving device for detachably connected to the coupling portion of said control rod for operation by the user to rotate said control rod, said rotary driving device comprising a driving rod for output of a rotary driving force applied by the user, said driving rod having a front coupling portion for engaging the coupling portion of said control rod.

8. The blind lifting control mechanism as defined in claim 7, said rotary driving device is manually operated.

9. The blind lifting control mechanism as defined in claim 8, wherein said manually operated rotary driving device comprises a L-shaped crank arm, said L-shaped crank arm having a first end terminating in said driving rod and a second end, a sleeve sleeved onto said driving rod for free rotation relative to said driving rod and said L-shaped crank arm, and a grip perpendicularly extended from the second end of said L-shaped crank arm.

10. The blind lifting control mechanism as defined in claim 7, wherein said rotary driving device is motor driven, said motor-driven rotary driving device having a reversible motor adapted to rotate said driving rod, a power supply adapted to provide the necessary working voltage to said reversible motor, and switch means adapted to control the rotation of said reversible motor.

11. A blind lifting control method of controlling the rotation of bobbins in a headrail of a blind to roll up or let off lift cords of said blind to further lift or lower the blind body of said blind by rotating a control rod to further drive a transmission mechanism in said headrail of said blind to rotate said bobbins and enabling said transmission mechanism to prohibit transmission of a rotary driving force in direction from said bobbin toward said control rod after stoppage of the rotation of said control rod is stopped.

12. The blind lifting control method as defined in claim 11 further comprising a crank handle connected at a bottom end of said control rod for rotating said control rod.

13. The blind lifting control method as defined in claim 11 further comprising a rotary driving device detachably connected at bottom end of said control rod, said rotary driving device being adapted to be driven manually or electrically to rotate said control rod.
